(19) United States
(12) Patent Application Publication
(10) Pub. No.: US 2006/0230309 A1
(43) Pub. Date: Oct. 12, 2006

(54) System for remote fault management in a wireless network

(76) Inventors: Mark A. Kromer, Harleysville, PA (US); John Anthony Wood, Alpharetta, GA (US)

Correspondence Address: Perkins Smith & Cohne LLP, One Beacon Street, Boston, MA, 02108, US

(21) Appl. No.: 11/403,014

(22) Filed: Apr. 12, 2006

Related U.S. Application Data
(60) Provisional application No. 60/670,551, filed on Apr. 12, 2005.

(51) Int. Cl. G06F 11/00

(52) U.S. Cl. 714/11

(57) ABSTRACT

This invention relates generally to network management in large telecommunications networks. A system and method capable of providing signal consolidation, replication, and correlation at a fault processor in order to allow signal information to remain visible at the fault processor even when communications between the fault processor and subordinate processors to which the signals are arriving have been lost or subordinate processors are offline.

### CROSS REFERENCE TO RELATED APPLICATIONS

The present application claims priority to U.S. Provisional Application No. 60/670,551 filed Apr. 12, 2005, entitled SYSTEM FOR REMOTE FAULT MANAGEMENT IN A WIRELESS NETWORK which is incorporated herein by reference.

### BACKGROUND

Network management systems (NMSs) and Managers of Managers (MOMs) are now in wide use for the purpose of facilitating administration, configuration, and monitoring of large, complex wireless, wireline and data networks, including 2.5 G and 3 G data networks, Global System for Mobile communications (GSM), General Packet Radio Service (GPRS), optical, fixed voice, Next Generation Networks (NgN), Voice Over Packet (VoP), and Internet Protocol (IP). Some NMSs such as, for example, the Operational Support System (OSS) suite of AGILENT TECHNOLOGIES®, which combines network management, service assurance (NETEXPERT®), and revenue assurance solutions, are implemented using object-oriented computer programming development environments. In these systems, it is convenient to represent physical elements of a real-world network, such as routers, switches, and their components, in terms of programmatic objects and instances of the objects. Physical managed objects are resources that are defined by physical hardware components. Examples of physical managed objects that are useful in representing a telecommunication network include nodes, cards, ports, and trunks. Logical managed objects, in contrast, are supported by one or more hardware components. Examples of logical managed objects include end-to-end user connections, and endpoints of user connections.

Large telecommunications networks are subject to occasional and/or frequent faults, which result in alarms being raised. Fault alarm incidents (or messages) are routinely generated for the various components of a network to allow the service provider to monitor the operational state of the network. Fault management systems generally receive and process these alarm incidents in accordance with fault management objectives as defined by the service provider. Some service providers organize their networks geographically, but do not interconnect their independent, regionally-based fault management installations, and thus, do not take full advantage of their systems' hardware and capabilities.

A single network fault may generate a large number of alarms over space and time. In large, complex networks, simultaneous network faults may occur, causing the network operator to be flooded with a high volume of alarms. The high volume of alarms greatly inhibits the ability of an operator of a NMS to identify and locate the responsible network faults.

Existing solutions that utilize a thin-client approach to manage the high volume of alarms provide the user with a consolidated view of alerts from monitored systems with which the viewing system is in electronic communication as long as the viewing system is online and active. Once the monitored systems are taken offline or communications are lost, the list of alerts from that monitored system is lost. The thin-client approach may not be capable of determining the current status of the thin-client connection and therefore may not indicate to a user that communications have been interrupted or are offline. Further, the thin-client approach does not allow for correlations to be achieved using the combined list of alerts since there is no resident storage. Once a thin-client connection is lost, it must be re-established and all dynamic storage is lost.

Existing solutions that utilize the sharing of database connections in order to combine systems attempt to combine database tables from individual systems and provide a single view of the combined tables. Database sharing solutions do not provide for the SP resident storage of correlations or communication status alarms/data. Database sharing solutions attempt to utilize the SP wide area network to combine database tables which can be inefficient and costly, and can use excessive bandwidth and are susceptible to latency and packet loss issues that cause inconsistencies.

What is needed is a system and method of cross-domain replication and correlation of large numbers of network alarms from independent (e.g., regionally organized) network servers. Among the many advantages of such a system is to reduce resource requirements in the network. What is further needed is a user interface that consolidates alerts from the independent network servers and associates each alert with a system of origin. This type of association could allow a user to manage the independent network server elements from the viewpoint of that system, while at the same time allowing the user to manage alerts from a system wide perspective without having the view of alerts restricted to a single network server. What is still further needed is a system and method that allow a user to manage a network from a single system, across the entire network, by, for example, product line or any other desired network element attribute.

### DESCRIPTION OF THE SEVERAL VIEWS OF THE DRAWING

FIG. 1 (PRIOR ART) is a schematic block diagram illustrating the autonomous signal processing systems of the prior art;

FIG. 2 is a schematic block diagram of the major components of the system of the present invention;

FIGS. 2A and 2B are flowcharts describing the method of creating other signals;

FIG. 2C is a flowchart describing the method of modifying other signals;

FIGS. 2D and 2E are flowcharts describing the method of updating other signals;

FIG. 3 is a schematic block diagram illustrating the system of the present invention including examples of supporting technology, and improvements to supporting technology provided by the present invention in bold typeface; and

FIG. 4 is flow diagram of the method of the present invention.

### DETAILED DESCRIPTION

Embodiments according to the present teachings are now described more fully hereinafter with reference to the accompanying drawings. The following configuration description is presented for illustrative purposes only. Any computer configuration satisfying the speed and interface requirements herein described may be suitable for implementing the system of the present teachings.

The illustrative embodiment according to the present teachings is built upon a system such as, for example, NETEXPERT® Visual Services Management (VSM) available from AGILENT TECHNOLOGIES®, with capabilities including, but not limited to,

(a) managing a variety of wireless and wireline technologies, including, for example, GSM, GPRS, optical, fixed voice, NgN, VoP, and IP;

(b) supporting Simple Network Management Protocol (SNMP), Transmission Control Protocol/Internet Protocol (TCP/IP), Common Object Request Broker Architecture (CORBA), Common Management Information Protocol (CMIP), Telnet, Structured Query Language (SQL), X.25, American Standard Code for Information Interchange (ASCII)/legacy, Synchronous Optical Networking (SONET)/Synchronous Digital Hierarchy (SDH), and Transaction Language 1 (TL1);

(c) managing other signals 21 using, for example, a JAVA-based signal management interface;

(d) sharing data among similar systems using peer-to-peer distribution application;

(e) supporting integration and sharing of data across applications and domains;

(f) providing signal correlation and fault/network management;

These various aspects of the supporting technology are discussed in the following paragraphs.

Managing a variety of wireless and wireline technologies can include, but is not limited to, providing IP data services, gathering data from individual applications, servers, network links, and networking equipment to assess end-to-end service performance, automatically discovering network elements, building a graphical model of the network, associating each network element with key tests and measurements needed to verify service availability and performance, creating service level agreements, monitoring internet services and protocols, monitoring value-added services and protocols such as, for example, Voice over Internet Protocol (VoIP), and Wireless Application Protocol (WAP), and managing performance of regional networks.

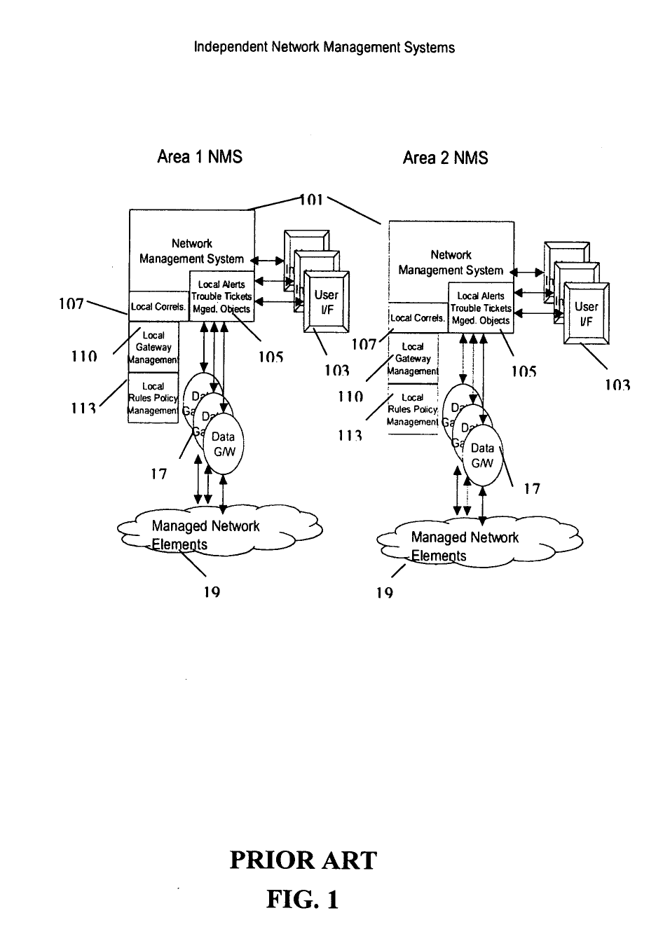

Referring now to FIG. 1 (PRIOR ART) supporting SNMP, TCP/IP, CORBA, CMIP, Telnet, SQL, X.25, ASCII/legacy, SONET/SDH, and TL1 protocols, and sharing data, can include, but are not limited to, providing rule-based gateway 17 that (1) executes applications and manages working sessions to network devices, element management systems (EMSs), and other protocol agents, referred to herein as managed network elements 19, (2) monitors, decomposes, analyzes, and responds to messages received from the managed network elements 19, and sends commands or data in response to data analysis or user-generated commands, (3) normalizes communication layer and data type differences to a common format, (4) consolidates data into a single signal if possible, (5) updates a management information base (MIB) when new managed network elements 19 are found, (6) enables automation of human interaction through dialogs, (7) identifies messages that are important to the user and ignores messages that are not, (8) parses important attributes out of the message stream to normalize various message streams into a set of events with common attributes, (9) filters, suppresses, thresholds, and correlates events at gateways 17 for increased distribution and scalability, (10) triggers bi-directional commands with gateways 17 if necessary to further poll and/or configure the source of events, (11) forwards data requiring additional analysis from gateway 17 to a network management system 101 such as, for example, the Intelligent Dynamic Event Analysis Subsystem (IDEAS) server available from AGILENT TECHNOLOGIES®. Gateway 17 operations can be managed by subordinate processor (SP) gateway management 110.

Continuing to refer to FIG. 1, managing signals and providing signal correlation can include, but are not limited to, automated correlation and root cause analysis, shown illustratively as SP correlations 107, SP rules policy management 113, signal management and geographical views, filtering and signal charting for organizing signals, managing system and network health with polling scenarios, and managing SP underutilized inventory. Providing fault/network management can include, but is not limited to, monitoring network events to detect and isolate network problems automatically, ensuring high-quality service to customers, using filters, suppression, thresholding, escalation and correlation, reducing mean-time-to-repair, monitoring faults, and locating network and element outages from a single signal management console.

Continuing to refer to FIG. 1, network management system 101 can be a rule-based, object-oriented engine, that (1) maintains a network model including inherited classes, attributes, objects, and relationships, (2) performs administration, security and logging tasks, (3) diagnoses and responds to events and requests forwarded from gateways 17 and application interfaces, (4) maintains the logical, physical and graphical state of the managed network elements 19 and their effects on related objects, (5) manages SP signals 105, thresholds, polling, paging, and trouble tickets, (6) initiates and manages dialogs to send commands to managed network elements 19, (7) performs logical operations on attribute values, (8) services the needs of user interfaces 103, (9) initiates paging, (10) manages and maintains objects and relationships, and (11) provides system log information. The system can include an embedded expert system that can, but is not limited to, (1) intelligently analyze data and coordinate notification and automated actions, (2) diagnose and resolve problems in real time (fault management), (3) provision equipment and activate services (configuration management), (4) analyze load and usage patterns and resource utilization (performance management), (5) process, store and provide access to network usage data (accounting management), (6) execute application behavior through user-defined rules, (7) modify the rules such as, for example, root cause analysis (pin-point the root cause by traversing relationships between network elements 19 to suppress and correlate SP signals 105 to the primary source of the outage), (8) suppress, threshold, escalate, and correlate faults, (9) create custom rules to specify an event that bypasses the pre-specified policies, and (10) specify a pre/post-event generation.

Still further referring to FIG. 1, the conventional system can also provide packaged correlation scenarios, electronic coupling of multiple network management systems 101, data mediation between the various managed network elements 19, interaction with various types of fault messages and performance statistics across a wide variety of communication protocols, reception of normalized data from intelligent gateways 17 and protocol agents, creation of objects in real-time either during the incoming signal or through an inventory file, learning and creating new signal types, storing rules, dialogs, configuration, and user authorization, and allowing users to create signal filters and save them by name. Additionally, the system and method according to the present teachings can be built upon a system, such as, for example, the NXRI™ product available from AGILENT TECHNOLOGIES®, that provides an integration between help desk functions and functions such as fault, performance, traffic, testing, and configuration. Such a system can provide the user a single interface to create and monitor the status of trouble tickets, and can automatically or manually transfer detected and analyzed conditions to a help desk.

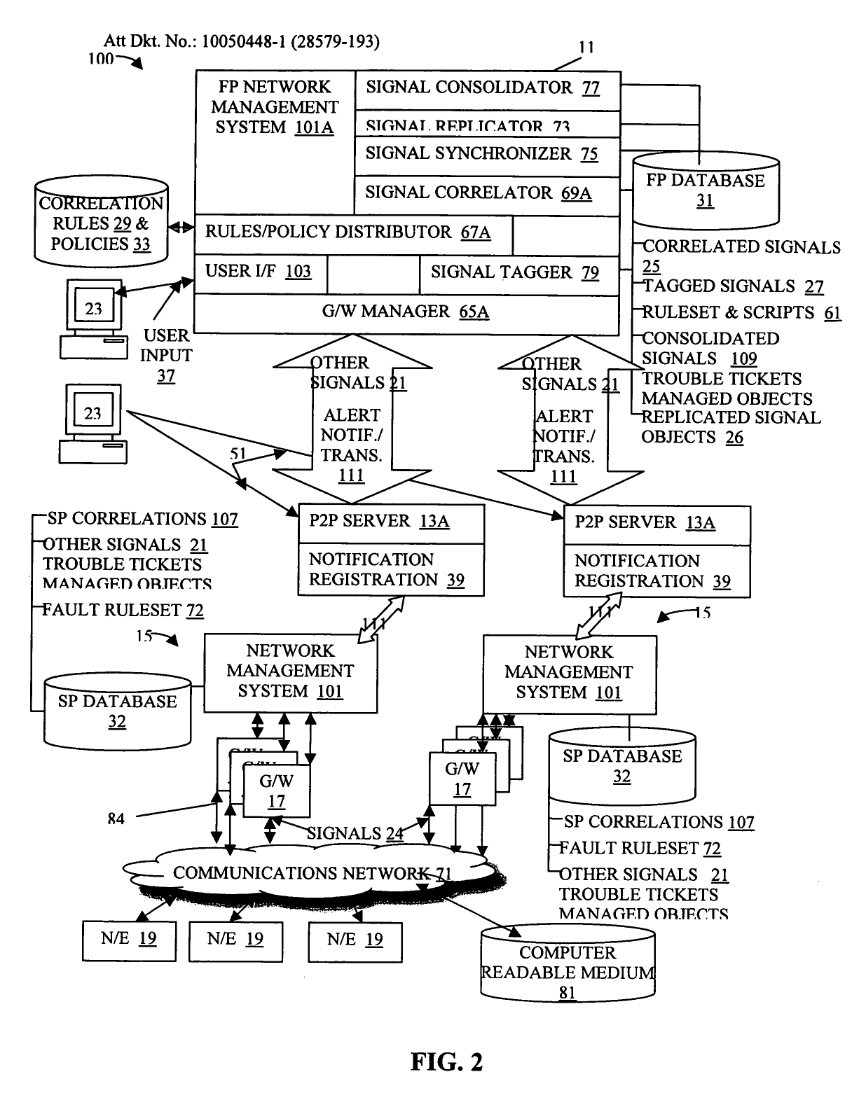

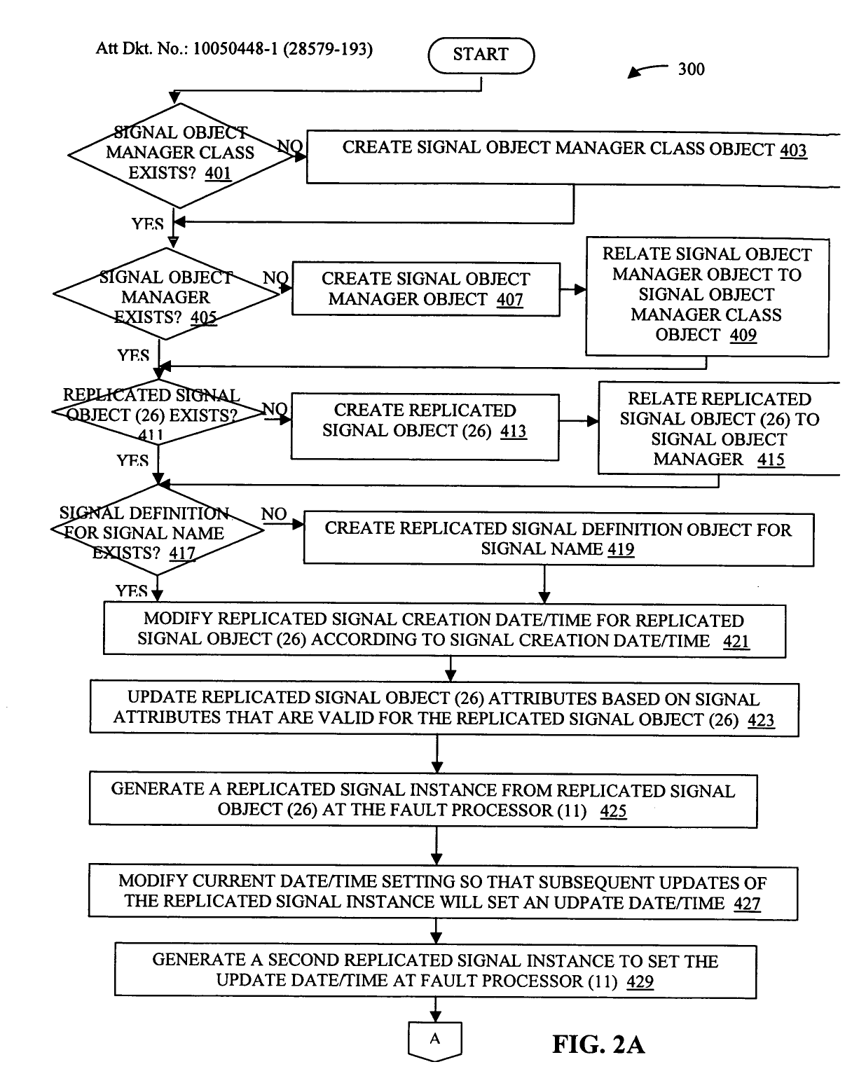

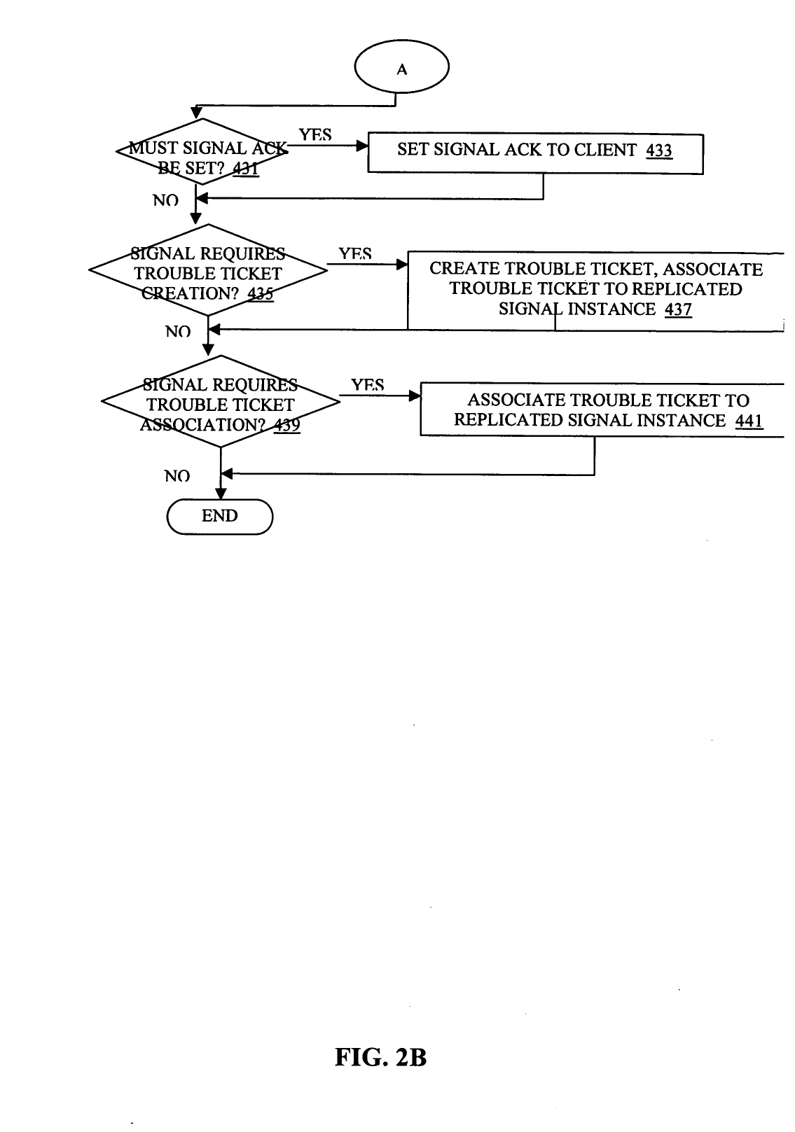

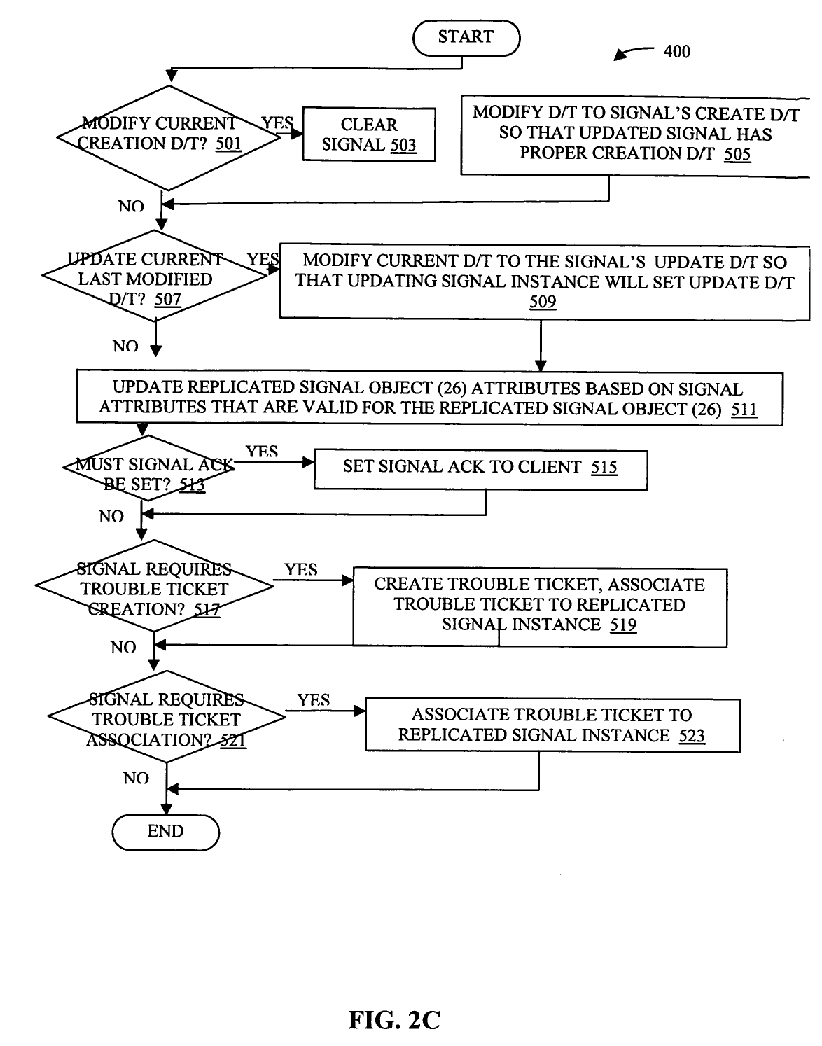

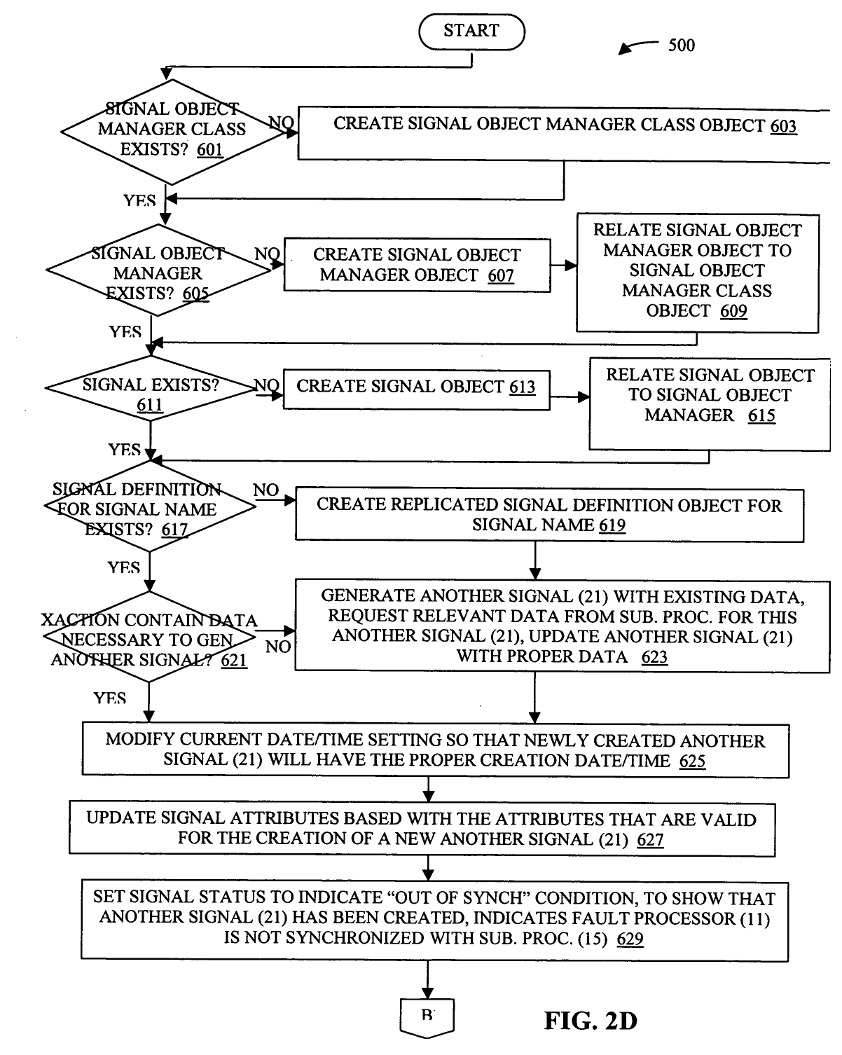

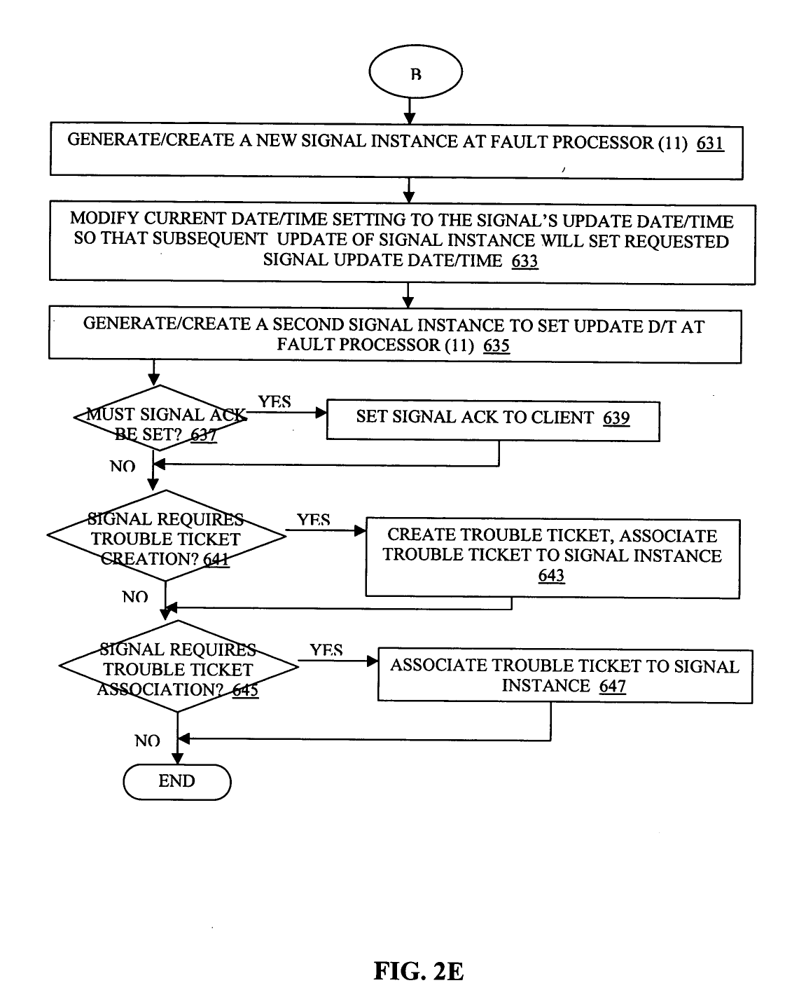

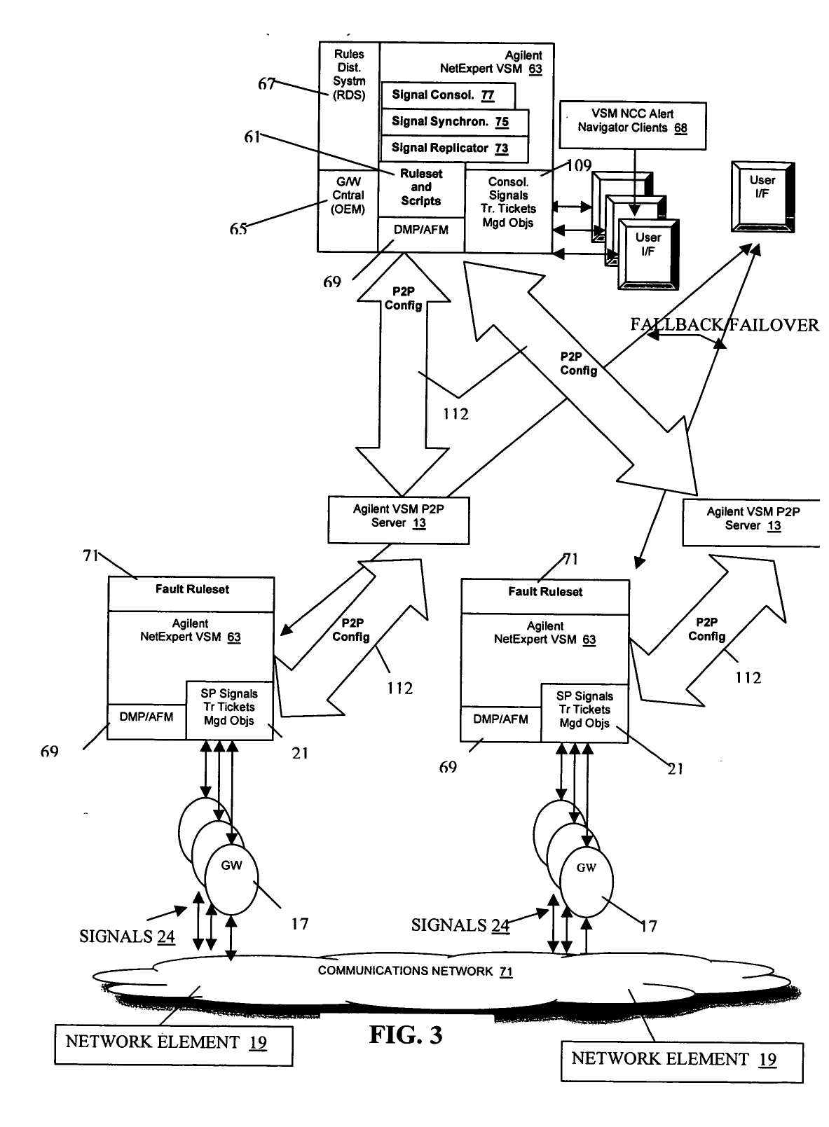

Referring now to FIGS. 2 and 3, the system and method of the present teachings customize the systems upon which they are built (described above and shown in regular unbolded font in FIG. 3) with an application ruleset and scripts 61 that are designed to facilitate the desired interactions between fault processor 11 and subordinate processors 15. Communications between fault processor 11 and subordinate processors 15 are provided by peer-to-peer server 13A that is configured for each subordinate processor 15. Interface between the subordinate processors 15 and network elements 19 is provided by gateways 17 configured to be in electronic communications with the subordinate processors 15.

Referring now to FIG. 2, system 100 can include, but is not limited to, a fault processor 11, subordinate processors 15, gateways 17, and peer-to-peer servers 13A. System 100 and method 200 allow, through the customization described herein, a conventional network management system 101 such as, for example, VSM, to act as a consolidation point for SP signals 105 that are initially created at subordinate processors 15 (which are also, in the illustrative embodiment, customized conventional products such as VSM). Customization allows for fault processor 11 to distinguish between subordinate processors 15 with which it is in electronic communication through peer-to-peer servers 13A.

Continuing to refer to FIG. 2, fault processor 11 is designed to provide consolidated signals 109, through use of signal consolidator 77, and replicate another signal 21, through use of signal replicator 73, that are present at subordinate processors 15. Consolidation occurs when another signal 21 is duplicated across multiple subordinate processors 15. Fault processor 11 can allow a signal instance to exist only once, and therefore the last subordinate processor 15 to report a duplicated signal will be the subordinate processor 15 of record for that another signal 21. Signal replication involves dissecting the attributes and other properties of another signal 21 and executing code to replicate the attributes and properties of another signal 21 at fault processor 11. Signal correlator 69A can correlate signals 15 across all subordinate processors 15 using correlation rules 29 and correlation policies 33, both possibly user-defined, to act upon consolidated signals 109 to create correlated signals 25.

Referring to FIGS. 2A and 2B, signal replicator 73 replicates signals either when they are received from subordinate processor 15, or during a synchronization process. In either case, data received from subordinate processor 15 can include, but are not limited to, the following: Alert Managed Object Name, Alert Managed Object Class, Alert Managed Object Manager, Alert Managed Object Manager Class, Alert Name, Alert Severity, Alert Description, Alert Create Time/Date, Alert Update Time/Date, Alert Times/Count (Incremental count of occurrences), Alert Acknowledge Operator, Alert Detail Description 1, Alert Detail Description 2, Site Tag (P2PSite Name of Site System of Origin), Raw Data Manager Port Key, Raw Data Archive Offset, Raw Data Archive Length, and Custom Extended Alert Attributes. Signal replicator 73 can execute the steps of method 300 during creation of a new signal instance. Method 300 can include, but is not limited to, the steps of if a signal object manager class does not exist (decision step 401), creating the signal object manager class object (method step 403). Method 300 can also include the steps of if signal object manager does not exist (decision step 405), creating a signal object manager object (method step 407) and relating the signal object manager object to the signal object manager class object. Method 300 can also include the step of if a replicated signal object (26) does not exist (decision step 411), creating the replicated signal object (26) (method step 413) and relating the replicated signal object (26) to the signal object manager (method step 415).

Continue to refer to FIGS. 2A and 2B, method 300 can also include the step of if a signal definition for a signal name for the other signal 21 does not exist (decision step 417), creating a replicated signal definition object for the signal name (method step 419). Method 300 can further include the steps of modifying the current date/time setting to the signal's create date/time so that the newly created signal will have the proper creation date/time setting (method step 421), updating signal attributes with the attributes provided in the signal data stream that are valid for the creation of a new signal instance (method step 423), such as, for example, severity, description, detail descriptions, and extended signal attributes, generating/creating the new signal instance fault processor 11 (method step 425), modifying the current date/time setting to the signal's update date/time so that the subsequent updating of the replicated signal instance will set the requested signal update date/time (method step 427), and generating/creating the signal instance a second time to set the update date/time fault processor 11. If a signal acknowledgement must be set (decision step 431), method 300 can include the step of setting signal acknowledgement to client 23 (method step 433). If the replicated signal instance requires association or creation of a trouble ticket (decision step 435), method 300 can include the steps of creating the trouble ticket and associating the trouble ticket to the signal instance (method step 437). If associating the trouble ticket is required without trouble ticket creation (decision step 439), method 300 can include the step of associating an existing trouble ticket to the signal instance (method step 441).

Referring now to FIG. 2C, signal replicator 73 can execute the steps of method 400 during updating of an existing signal instance. Method 400 can include, but is not limited to, the steps of if the current creation date/time needs to be modified (decision step 501), clear another signal 21 (method step 503) and modify the current date/time setting to the signal's create date/time so that the updated signal will have the proper creation date/time setting (method step 505). If the current last modified date/time needs to be modified (decision step 503), method 400 can include the step of modifying the current date/time setting to the signal's update date/time so that updating of the signal instance will set the requested signal update date/time (method step 509). Method 400 can further include the step of updating signal attributes with the attributes provided in the signal data stream that are valid for the creation of a new signal instance such as, for example, severity, description, detail descriptions, and extended signal attributes provided (method step 511). If a signal acknowledgement must be set (decision step 513), method 400 can include the step of setting signal acknowledgement to requested client 23 (method step 515). If another signal 21 requires association or creation of a trouble ticket (decision step 517), method 400 can include the steps of creating the required trouble ticket and performing association to associate trouble ticket to signal instance (method step 519). If association is required (decision step 521), method 400 can include the step of associating the existing trouble ticket to the signal instance (method step 523). Trouble tickets and signal acknowledgements are processed according to the method described with respect to updating an another signal 21 because the existence of a signal instance dictates the actions the system must take with respect to trouble tickets and signal acknowledgements.

Referring now to FIGS. 2D and 2E, signal replicator 73 can execute the steps of method 500 during updating of a signal for whose update request was received at central fault processor 11 from subordinate processor 15, but which fault processor 11 has no knowledge of, a situation that occurs when subordinate processor 15 and fault processor 11 are not in synchronization with each other. To manage this situation, method 500 can include, but is not limited to, the steps of determining if signal object manager class does not exist (decision step 601), method 500 can include the step of creating a signal object manager class object (method step 603). If a signal object manager does not exist (decision step 605), method 500 can include the steps of creating a signal object manager object (method step 607) and relating it to the signal object manager class object (method step 609). If a signal object does not exist (decision step 611), method 500 can include the steps of creating the signal object (method step 613) and relating it to the signal object manager (method step 615). If a signal definition does not exist for the signal name (decision step 617), method 500 can include the step of creating the signal definition object for the signal name (method step 619). At this point, depending upon the update transaction, additional data required to properly re-create the signal instance may or may not be present in the data provided by subordinate processor 15. Updates normally only contain relevant data and do not contain the full set of data items that are present within a new signal creation transaction. If this transaction does not contain all the data necessary for generating a valid signal (decision step 621), method 500 can include the step of generating a signal with existing data but spawning a separate task that can return to the subordinate processor 15 that initiated this transaction and request relevant data for this signal instance, and once the required data is acquired, returning these data to fault processor 11 and updating this signal instance with proper data entries (method step 623). These steps can occur after the update action is complete. Method 500 can further include the steps of modifying the current date/time setting to the signal's create date/time so that the newly created signal will have the proper creation date/time setting (method step 625), updating signal attributes with the attributes provided in the signal data stream that are valid for the creation of a new signal instance (method step 627), such as, for example, severity, description, detail descriptions, and extended signal attributes provided, setting signal status to indicate “out of sync” to show that this signal has been properly created, but indicates that fault processor 11 requires synchronization with subordinate processor 15 since an update should not be received on any signal instance that is not present (method step 629), generating/creating the new signal instance fault processor 11 (method step 631), modifying the current date/time setting to the signal's update date/time so that the subsequent updating of the signal instance will set the requested signal update date/time (method step 633), and generating/creating the signal instance a second time to set the update date/time fault processor 11 (method step 635). If a signal acknowledgement must be set (decision step 637), method 500 can include the step of setting the signal acknowledgement to a requested client (method step 639). If the signal requires association or creation of a trouble ticket (method step 641), method 500 can include the steps of creating the required trouble ticket and associating the trouble ticket to a signal instance (method step 643). If it is required to associate an existing trouble ticket to a signal instance (decision step 645), method 500 includes the step of associating the trouble ticket to a signal instance (method step 647). Signal replicator 73 can also clear existing signals by (1) dissociating any trouble tickets associated with another signal 21 and (2) clearing another signal 21 from fault processor 11 without clearing another signal 21 from subordinate processor 15. To clear a non-existent signal, signal replicator 73 notifies other elements of fault processor 11 that an out of sync condition exists.

With further reference to FIG. 2, while fault processor 11 is primarily responsible for receiving signal transactions/notifications 111 from subordinate processors 15 and replicating other signals 21, subordinate processors 15 perform initial processing, validation, and determination of other signals 21 from signals 24 based on SP database 32 including, but not limited to, fault ruleset 72 and SP correlations 107. Subordinate processors 15 are responsible for communications and data manipulation to and from the managed network elements 19 via their associated gateways 17. Fault processor 11 registers for signal notifications/transactions 111 through a notification registration 39, receives signal notifications/transactions 111 and other signals 21 from each subordinate processor 15, and replicates the signals at fault processor 11. Because subordinate processors 15 can perform signal processing, the amount of signal processing that fault processor 11 has to perform can be reduced, and therefore the amount of data and attributes required at fault processor 11 can be reduced. Additionally, because subordinate processors 15 are interfacing with gateways 17, fault processor 11 may not require additional processes (such as gateway processes) to be restarted before fault processor 11 can become functional.

With still further reference to FIG. 2, subordinate processors 15 are considered the systems of record for other signals 21. Fault processor 11 is responsible for synchronizing, through signal synchronizer 75, and replicating, through signal replicator 73, other signals 21 that are resident at each subordinate processor 15 at fault processor 11. Fault processor 11 can provide various granularities of synchronizations, and can request an update from subordinate processor 15 to upload all existing other signals 21 onto fault processor 11 and to synchronize other signals 21 at fault processor 11. Signal synchronization consists of the clearing, creation, reassigning, and/or updating of signal notifications III at fault processor 11 to properly mirror other signals 21 that exist at subordinate processor 15 using the criteria of the synchronization request. All user-invoked signal notifications/transactions 111, such as, for example, clear, acknowledge, and trouble ticket actions, that are made at fault processor 11 are directed to the system of origin for the selected other signal(s) 21 and the system of origin is responsible for processing the signal notification/transaction request 111 and submitting the resulting action back to fault processor 11. In this way, subordinate processors 15 are the systems of record for the signal notifications/transactions 111 and are responsible for the disposition of signal notification/transaction requests.

Continuing to refer to FIG. 2, in the illustrative embodiment, signal synchronizer 75 can execute, but is not limited to executing, the steps of set forth in the following state table.

| State | Status | State Description | Action | Alert/Class.Event |
|---|---|---|---|---|
| PERFORM | | Gather all signals from fault | | |
| | | processor (11) related to a | | |
| | | subordinate processor (15). | | |
| PERFORM | | Traverse the list of signals | | |
| | | received from subordinate | | |
| | | processor (15). Associate each | | |
| | | signal with a trouble ticket. | | |
| PERFORM | | Test if the signal exists in the | | |
| LOOP | | fault processor (11). | | |
| START | | | | |
| TEST-1 | | Perform second level TEST-2 | | |
| | TRUE-1 | Does the existing signal contain | | |
| | | ‘OUT OF SYNC Indication’? | | |
| TEST-2 | | Clear signal status messages | | |
| | | and set signal status to 0. | | |
| | TRUE-2 | No action taken. | | |
| | FALSE-2 | No action taken. Skip TEST-3 | | |
| | FALSE-1 | Compare a First Date/Time and | | |
| | | a Last Date/Time associated | | |
| | | with each signal. | | |
| TEST-3 | | No action taken. | | |
| | FIRST | Generate/Create this signal after | | |
| | DATE/TIME | setting attributes including, but | | |
| | NOT | not limited to, | | |
| | EQUAL | First Date/Time, Last | | |
| | | Date/Time, Severity, Count, | | |
| | | Description, Detail descriptions, | | |
| | | to values provided by | | |
| | | subordinate processor (15). | | |
| | | Perform acknowledge if | | |
| | | necessary. Create and associate | | |
| | | a Trouble Ticket if necessary. | | |
| | | If required items do not exist, | | |
| | | create Manager Object, | | |
| | | Managed Object, Manager | | |
| | | Class Object and Alert | | |
| | | Definition. Set required | | |
| | | relationships and associations | | |
| | | between these objects. | | |
| | LAST | | | |
| | DATE/TIME | | | |
| | NOT | | | |
| | EQUAL | | | |
| | BOTH | Remove signal entries for both | | |
| | DATE/TIMEs | fault processor (11) and | | |
| | EQUAL | subordinate processor (15) | | |
| PERFORM | | | | |
| LOOP END | | | | |
| COMMENT | | Related items remaining at fault | | |
| | | processor (11) should be | | |
| | | cleared. | | |
| | | Related items remaining at | | |
| | | subordinate processor (15) are | | |
| | | new signals to be generated. | | |
| PERFORM | | Indicate current action. | Generate | P2PSyncClearInitiated |
| PERFORM | | Clear signals remaining at fault | | |
| | | processor (11). Disassociate any | | |
| | | trouble tickets before clearing. | | |
| PERFORM | | Indicate current action. | Generate | P2PSyncGenerateInitiated |
| PERFORM | | Generate signals remaining | | |
| | | within the subordinate processor (15). | | |
| | | Generate/Create these signals | | |
| | | individually after setting | | |
| | | attributes that can include, but | | |
| | | are not limited to, First | | |
| | | Date/Time, Last Date/Time, | | |
| | | Severity, Count, Description, | | |
| | | Detailed descriptions to values | | |
| | | provided at subordinate | | |
| | | processor (15). Perform | | |
| | | acknowledgement if necessary. | | |
| | | Create and associate trouble | | |
| | | ticket if necessary. | | |
| | | If required items do not exist, | | |
| | | create Manager Object, | | |
| | | Managed Object, Manager | | |
| | | Class Object and Alert | | |
| | | Definition. Set required | | |
| | | relationships and associations | | |
| | | between these objects. | | |
| COMMENT | | The same logic for signal | | |
| | | creation should be reproduced | | |
| | | within variations of sync upload | | |
| | | routines. | | |
| PERFORM | | Remove synchronization in | Clear | P2PSyncInProgress |
| | | progress status signal. | | |
| PERFORM | | Indicate process completed. | Generate | P2PSyncCompleted |
| END | | EXIT | EXIT | |

With even still further reference to FIG. 2, a system administrator for subordinate processor 15 is allowed to define criteria by which selected other signals 21 may be restricted from accepting certain user signal notification/transaction requests such as a clear request. Fault processor 11 requests actions to be processed at subordinate processor 15 and waits for the result to be received as a subsequent signal notification/transaction 111. User signal notification/transaction 111 requests that are initiated at fault processor 11 and are not successfully communicated to the system of origin are marked as pending action items. These pending action items may be re-submitted to the system of origin as individuals or as a group. This re-submission of pending requests is the initial action processed during a synchronization request.

With yet still further reference to FIG. 2, since fault processor 11 consolidates other signals 21 from subordinate processors 15, and records, through signal tagger 79, system of origin of another signal 21, the ability to change the origination of data input into subordinate processor 15 by means of, for example, changing gateway processes, is essentially transparent to client 23. Transferring responsibility of managing a managed network element 19 from one subordinate processor 15 to another is relatively transparent to client 23 managing other signals 21. This ability to transfer management responsibility from one subordinate processor 15 to another subordinate processor 15 allows subordinate processors 15 to be taken out of the communications network 71 for maintenance, for example, without disrupting the constant flow of data from managed network element 19. A history of consolidated signals 109 is retained at fault processor 11, and new signal notification s/transactions 111 can reassign other signals 21 to a different system of origin.

Referring still to FIG. 2, fault processor 11 can interface with conventional filtering products such as the ALERT NAVIGATOR available from AGILENT TECHNOLOGIES®. System 100 and method 200 can define extended signal attributes to facilitate another signal 21 processing at fault processor 11. These attributes, associated with each consolidated signal 109 at fault processor 11, can include, but are not limited to, (1) an attribute to indicate the system of origin or subordinate processor 15 currently responsible for another signal 21, and (2) an attribute used to indicate fault processor-relevant signal status or actions undertaken, such as, for example, success, failure, or pending status. Any updates that are marked as pending updates may have their pending statuses cleared prior to those updates being processed via clearing the signal status attribute.

Continuing to refer to FIG. 2, fault processor 11 can receive messages including, but not limited to, (1) notifications of identified ‘Out of Sync’ conditions where an update was received for another signal 21 that did not previously exist, (2) status other signals 21 that allow fault processor 11 to identify if subordinate processor 15 is active or inactive (subordinate processors 15 set to inactive status do not submit SP updates made at fault processor 11 to subordinate processor 15, nor are updates received from subordinate processor 15 processed at fault processor 11), (3) healthchecks, initiated by fault processor 11 for insuring connectivity through polling and/or manual verification, verify that subordinate processor 15 receives a request from fault processor 11 and also that it is capable of responding to the request. Fault processor 11 can maintain attributes to indicate subordinate processor 15 connectivity that can include, but are not limited to, (1) online, in which subordinate processor 15 is active and connectivity is verified, (2) offline, in which subordinate processor 15 may be active but connectivity cannot be established/verified, and (3) inactive, in which subordinate processor 15 may be active but signal notifications/transaction 111 will not be processed. Fault processor 11 can save or store update requests made if connectivity with subordinate processor 15 is offline, such as for example, saving and storing any manual clear request, acknowledgement request, and trouble ticket actions.

Continuing to refer to FIG. 2, fault processor 11 can provide automatic downstream synchronization of all pending updates to subordinate processor 15 upon a synchronization request to subordinate processor 15. When synchronization is requested, pending actions to subordinate processor 15 are re-processed. Fault processor 11 can provide the ability to manually update pending requests or to individually submit pending updates to subordinate processor 15, or synchronization can be scheduled to happen automatically, for example, by using the built-in polling feature of VSM. Fault processor 11 can provide for multiple levels of synchronization based upon need, for example, but not limited to, (1) a quick synchronization that utilizes, for example, using VSM's operator GetRelatedAlerts for a Region to gather associated signals and base the update on a comparison of Alert Managed Objects (AMO), signal name, and trouble ticket, (2) a normal synchronization that utilizes, for example, utilizing VSM's operator GetRelatedAlerts for a Region to gather associated signals and base the update on the comparison of AMO, signal name, trouble ticket, date/time of signal creation, date/time of the update, (3) a full synchronization that utilizes VSM's operator GetAlerts for a selected subordinate processor 15 to gather associated signals, and base the update on the comparison of AMO, signal name, trouble ticket, date/time of signal creation, date/time of the update, (4) critical/major/normal severity synchronization that utilizes VSM's operator GetAlerts for selected subordinate processor 15 to gather associated signals that are of the severity, for example, critical, major, or normal only, and base the update on the comparison of AMOs, signal name, trouble ticket, date/time of signal creation, date/time of the update, with signals that are of the severity, for example, critical, major or normal only, and (5) a severity synchronization that utilizes VSM's operator GetAlerts for selected subordinate processor 15 to gather associated signals based upon a single selected severity of, for example, critical, major, minor, warning, indeterminate or normal, and base updates on the comparison of AMOs, signal name, trouble ticket, date/time of signal creation, date/time of the update, that match the single selected severity of, for example, critical, major, minor, warning, indeterminate or normal. Fault processor 11 can be made capable of synchronizing more than 1000 signals in less than one minute.

Continuing to refer to FIG. 2, fault processor 11 can use synchronization of other signals 21 to indicate subordinate processor 15 status and actions undertaken during a synchronization request. This synchronization of other signals 21 can contain descriptive messages that contain the current posted date/time and signal counts, where relevant, and other information such as, but not limited to, (1) the start time of the synchronization request, (2) the number of other signals 21 synchronized to subordinate processor 15, i.e. the pending updates, (3) the number of other signals 21 received from subordinate processor 15, (4) the number of other signals 21 determined to be cleared from fault processor 11, (5) the number of other signals 21 determined to be generated at fault processor 11, and (6) the time of completion of synchronization request. Fault processor 11 can re-assign another signal 21 from one subordinate processor 15 to another when gateway 17 is re-homed and a signal update is received for another signal 21 that already exists but for a different subordinate processor 15. Also, fault processor 11 can create, update, and clear log files for signal notifications/transactions 111 and processing activities along with any subordinate processor synchronizations.

Referring now to FIG. 3, an illustrative embodiment of the present invention can be built upon, but is not limited to being built upon, NETEXPERT® VSM 63, Rules Distribution System 67, VSM Network Control Center (NCC) Alert Navigator Clients 68, DMP/AFM™ 69 for correlating consolidated signals 109, and VSM Peer-tp-Peer (P2P) server 13, all available from AGILENT TECHNOLOGIES®, and GATEWAY CENTRAL™ 65 available from any of several Original Equipment Manufacturers. These supporting technologies have been previously discussed and are shown here to indicate their relationship to the elements of system 100 depicted in FIG. 2. The illustrative embodiment can also include bolded elements such as signal consolidator 77, signal synchronizer 75, and signal replicator 73, P2P configuration 112 (including many of the functions of signal notification/transaction 111) described previously, among other elements.

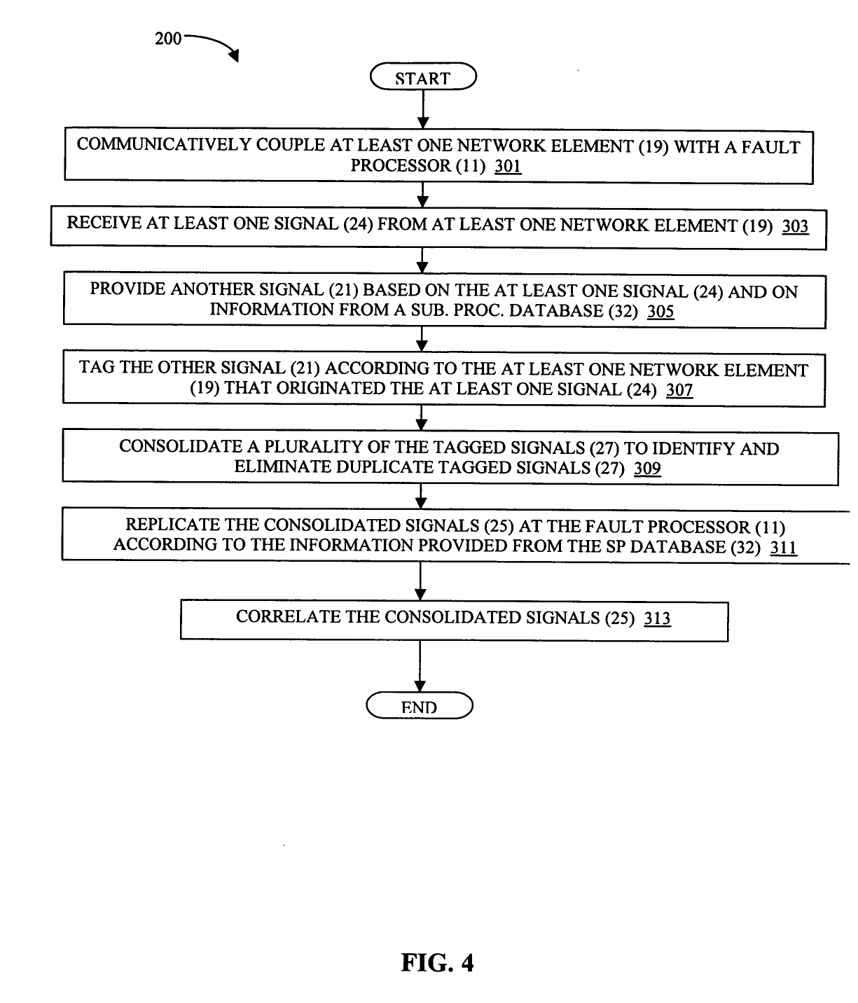

Referring now to FIG. 4, method 200 according to the present teachings can include communicatively coupling 301 a network element 19 with a fault processor 11, receiving 303 a signal 24 from the network element 19, forming 305 another signal 21 based on signal 24 and on information from a SP database 32, tagging 307 another signal 21 according to the originating one network element 19, consolidating 309 the tagged signals 27 to identify and eliminate duplicate signals, replicating 311 consolidated signals 109 at fault processor 11 according to the information in the SP database 32, and correlating 313 the consolidated signals 109 to provide single-point network monitoring. Correlating can include using correlation rules 29 and/or correlation policies to compute correlated signals 25. Correlation policies 33 can be dynamically created in real-time from an aggregation of other signals 21 and information in FP database 31. Synchronizing consolidated signals 109 between network element 19 and fault processor 11 is also possible in method 200, as well as communicatively coupling subordinate processor 15 with fault processor 11 and distributing correlation rules 29 to subordinate processor 15. Method 200 can include communicatively coupling subordinate processor 15 with network element 19, monitoring a failure of subordinate processor 15, and automatically switching from the failed subordinate processor 15 to an operational subordinate processor 15 after the failure in order to maintain the communicative coupling between network element 19 and fault processor 11. Alternatively, if fault processor 11 fails, failover channel 51 can be used to establish communications directly between client 23 and subordinate processors 15. In case of a failed subordinate processor 15, gateway manager 65A can move network elements 19 from the failed subordinate processor 15 to an operational subordinate processor 15.

With reference to FIGS. 2 and 4, method 200 (FIG. 4) can be, in whole or in part, implemented electronically. Signals representing actions taken by elements of system 100 (FIG. 1) can travel over electronic communications media 84 (FIG. 2). Method 200 can be implemented to execute on a fault processor 11 (FIG. 2) in at least one communications network 71 (FIG. 2). Control and data information can be electronically executed and stored on computer-readable media 81 (FIG. 2). Common forms of computer-readable media 81 include, for example, a floppy disk, a flexible disk, a hard disk, magnetic tape, or any other magnetic medium, a Compact Disk Read Only Memory (CDROM) or any other optical medium, punched cards, paper tape, or any other physical medium with patterns of holes, a Random Access Memory (RAM), a Programmable Read Only memory (PROM), and Editable Programmable Read Only Memory (EPROM), a FLASH-EPROM, or any other memory chip or cartridge, a carrier wave, or any other medium from which a computer can read.

Other variations of the described teachings will occur to those skilled in the art given the benefit of the described teachings. The following claims define the scope of the invention.

What is claimed is:

1. A system for providing single-point network monitoring comprising:
at least one network element communicatively coupled with a communications network;
at least one subordinate processor communicatively coupled with said communications network, said at least one subordinate processor capable of receiving at least one signal emanating from said at least one network element, said at least one subordinate processor capable of providing an another signal based upon information related to said at least one signal;
at least one peer-to-peer server communicatively coupled with said at least one subordinate processor, said at least one peer-to-peer server capable of monitoring a status of said another signal;
a fault processor communicatively coupled with said at least one subordinate processor through said at least one peer-to-peer server, said fault processor capable of receiving said another signal from said peer-to-peer server; and
at least one client communicatively coupled with said fault processor;
said fault processor capable of receiving said another signal from said subordinate processor and capable of tagging said another signal as originating at said at least one subordinate processor with which said another signal is associated,
said fault processor capable of consolidating a plurality of the tagged signals that are found to be duplicated,
said fault processor capable of replicating and correlating the consolidated signals; and
said fault processor capable of providing the correlated signals to said at least one client to enable the single-point network monitoring.

2. The system of claim 1 wherein said at least one client is capable of communicating directly with said at least one subordinate processor.

3. The system of claim 1 further comprising:
a gateway communicatively coupled with said at least one subordinate processor, said gateway capable of receiving said another signal from said at least one network element.

4. The system of claim 1 wherein said fault processor is capable of synchronizing said another signal between said at least one subordinate processor and said fault processor.

5. The system of claim 1 wherein the correlated signals are computed using correlation rules.

6. The system of claim 1 wherein the correlated signals are computed using correlation policies.

7. The system of claim 6 wherein the fault processor is capable of dynamically creating said correlation policies in real-time, said correlation policies are based on an aggregation of a plurality of said another signals and on information in a fault processor database.

8. The system of claim 1 wherein the fault processor is capable of providing the correlated signals to said at least one subordinate processor.

9. The system of claim 1 further comprising:
means for accepting user input at said at least one client;
means for establishing notification registration in said at least one peer-to-peer server; and
means for using said notification registration to transmit said user input to said at least one subordinate processor.

10. A method for providing single-point network monitoring comprising the steps of:
communicatively coupling at least one network element with a fault processor;
receiving at least one signal originating at the at least one network element;
providing another signal based on the at least one signal and on information from a subordinate processor database;
tagging the another signal according to the originating at least one network element;
consolidating a plurality of the tagged signals to identify and eliminate duplicate tagged signals;
replicating the consolidated signals at the fault processor according to the information provided from the subordinate processor database; and
correlating the consolidated signals to enable the single-point network monitoring.

11. The method of claim 10 wherein said step of correlating further comprises the step of:
computing the correlated signals using correlation rules.

12. The method of claim 10 wherein said step of correlating further comprises the step of:
computing the correlated signals using correlation policies.

13. The method of claim 12 further comprising the step of:
dynamically creating the correlation policies in real-time, wherein the correlation policies are based on an aggregation of signals and on information in fault processor database.

14. The method of claim 10 further comprising the step of:
synchronizing the consolidated signals between the at least one network element and the fault processor.

15. The method of claim 14 wherein said step of synchronizing comprises the step of:
dissociating any trouble tickets from the consolidated signals.

16. The method of claim 10 further comprising the steps of:
communicatively coupling at least one subordinate processor with the fault processor; and
distributing the correlation rules to the at least one subordinate processor.

17. The method of claim 16 further comprising the steps of:
communicatively coupling the at least one subordinate processor to the at least one network element;
monitoring a failure of the at least one subordinate processor; and
automatically switching from the failed at least one subordinate processor to an operational at least one subordinate processor after the failure in order to maintain the communicative coupling between the at least one network element and the fault processor.

18. A computer-readable medium having code capable of causing a computer to practice the method of claim 10.

19. A computer signal embodied in electromagnetic signals traveling over a communications network capable of causing a computer electronically connected to the communications network to practice the method of claim 10.

20. A system for providing single-point network monitoring comprising:
at least one network element capable of generating at least one signal;
a communications network communicatively coupled with said at least one network element;
at least one gateway communicatively coupled with said communications network, said at least one gateway capable of receiving said at least one signal from said at least one network element through said communications network;
a subordinate processor database including subordinate processor correlations, subordinate processor signals, and a fault ruleset;
at least one subordinate processor including at least one network management system communicatively coupled with said at least one gateway and said subordinate processor database;
said at least one subordinate processor capable of creating attributes based on said at least one signal and information in said subordinate processor database, said at least one subordinate processor capable of associating said attributes and said at least one signal with at least one another signal;
at least one peer-to-peer server communicatively coupled with said at least one network management system, said peer-to-peer server capable of monitoring said at least one another signal;
a fault processor including a fault processor network management system, a signal tagger, a signal consolidator, a signal replicator, a signal synchronizer, a signal correlator, a rules/policy distributor, a user interface, a gateway manager, correlation rules, correlation policies, a fault processor database including at least one correlated signal, at least one tagged signal, rulesets and scripts, and at least one consolidated signal; and
at least one client;
said signal tagger being capable of associating at least one said another signal with said at least one subordinate processor from which said at least one another signal originated, and capable of providing said at least one tagged signal;
said signal consolidator capable of locating and consolidating duplicate said at least one tagged signal, and capable of providing at least one consolidated signal;
said signal replicator capable of replicating said at least one signal based on said attributes associated with said at least one another signal;
said signal synchronizer capable of synchronizing said at least one another signal between said fault manager and said at least one subordinate processor;
said rules/policy distributor capable of providing said rulesets and scripts, correlation rules, and correlation policies to said at least one subordinate processor;
said user interface capable of receiving user input for dynamically modifying said rulesets and scripts;
said gateway manager capable of automatically directing said at least one subordinate processor to communicatively couple with said at least one gateway; and
said signal correlator capable of correlating a plurality of said at least one consolidated signal from a plurality of said at least one subordinate processors to enable the single-point network monitoring.
